(19) United States
(12) Patent Application Publication
(10) Pub. No.: US 2026/0112920 A1
(43) Pub. Date: Apr. 23, 2026

(54) Forta Vault™ — Sovereign Hybrid Infrastructure Harvest, Conversion, and Enforcement Platform

(71) Applicant: Tysalah Floyd Franklin, Peculair, MO (US)

(72) Inventor: Tysaiah Floyd Franklin, Peculiar, MO (US)

(21) Appl. No.: 19/353,559

(22) Filed: Oct. 8, 2025

(51) Int. Cl. H02J 50/00; G01W 1/10; H02J 3/00; H02J 50/20; H02J 101/24; H02N 1/04; H02N 2/00

(52) U.S. Cl. CPC H02J 50/001; G01W 1/10; H02J 3/003; H02J 3/004; H02J 50/005; H02J 50/20; H02N 1/04; H02N 2/001; H02J 2101/25

(57) ABSTRACT

A secure apparatus and method for harvesting, validating, storing, and conditionally releasing physical resources are disclosed. The apparatus includes an environmental harvesting assembly configured to physically collect energy or other resources from multiple environmental domains, a conversion module that transforms the collected resources into a usable output, and a storage module that physically retains the output. A dual-meter validation module independently measures harvested or stored quantities to detect physical discrepancies beyond predefined tolerance thresholds. A hardware security module maintains sealed operational statesgts, performs cryptographic signing, and enforces encoded physical release conditions, including zeroization upon detection of tampering. A tamper-detection module identifies unauthorized physical access or modification. An escrow-validation engine restricts physical release of stored resources until cryptographically verified authorization, compliance, or continuity conditions are satisfied, enabling autonomous, tamper-resistant, and auditable physical resource control across distributed infrastructure.

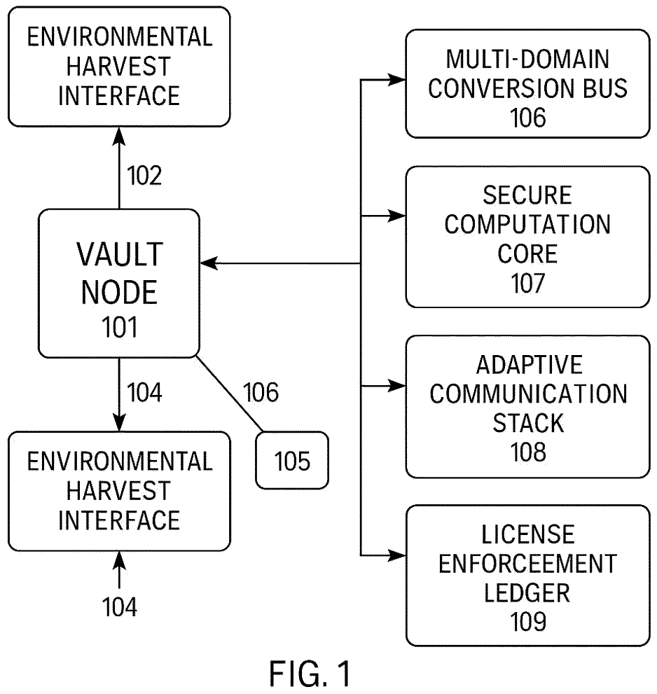

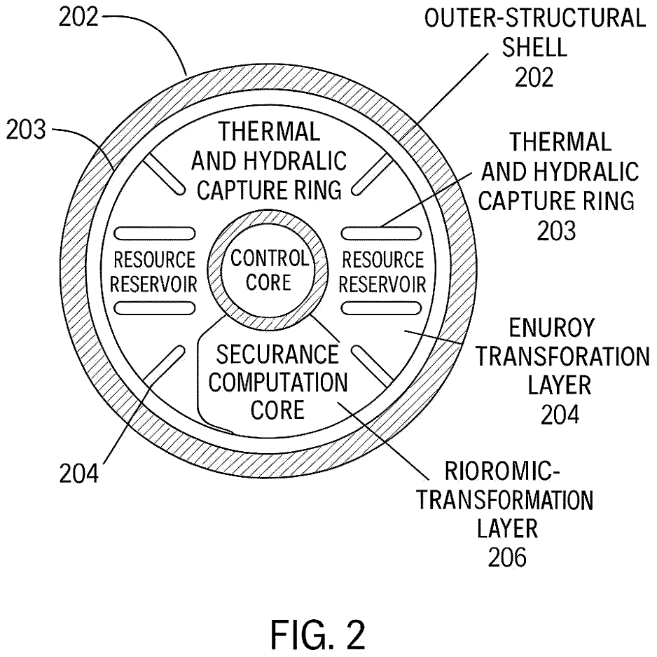

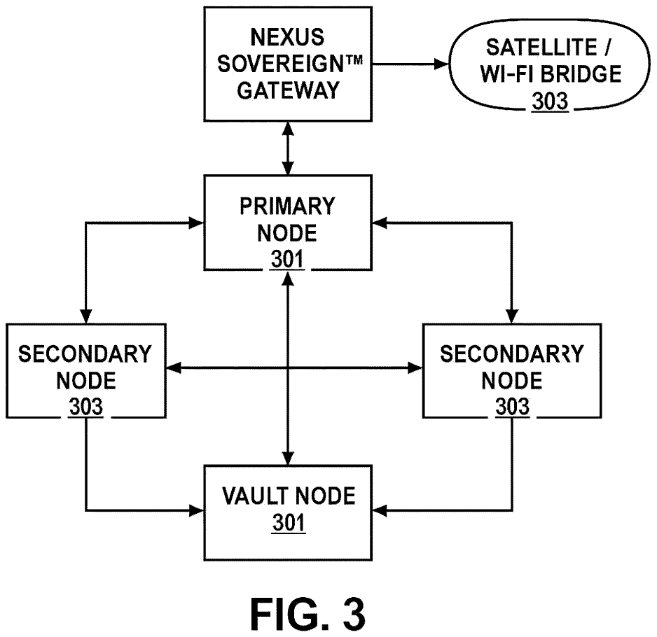

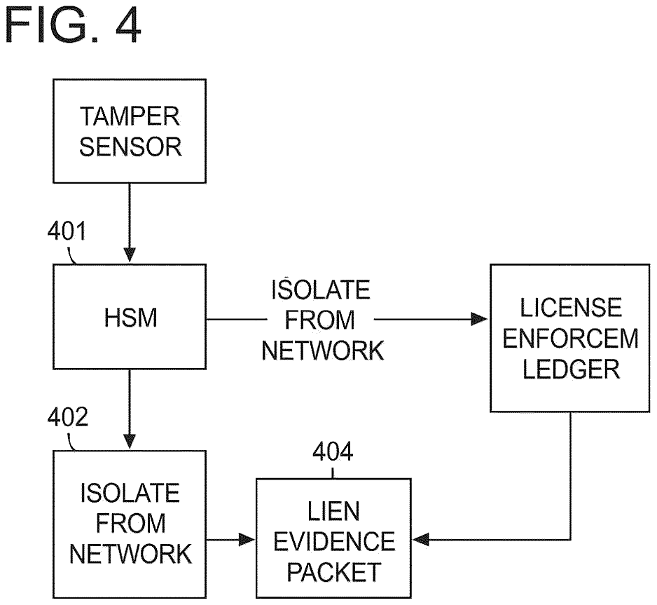

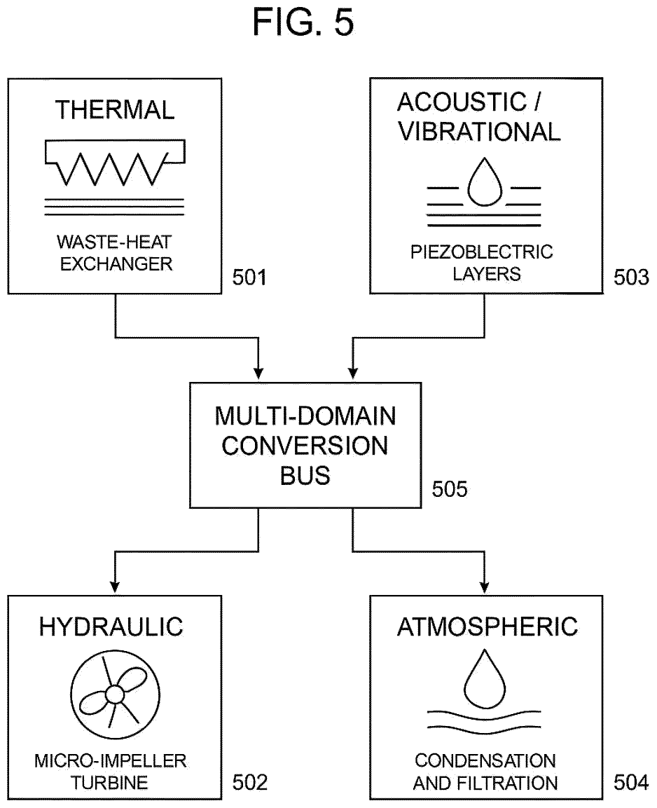

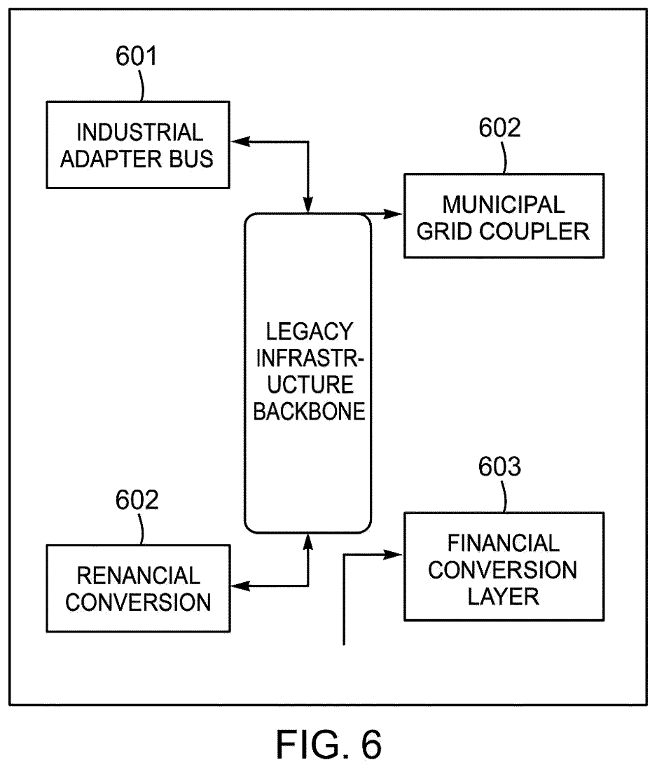

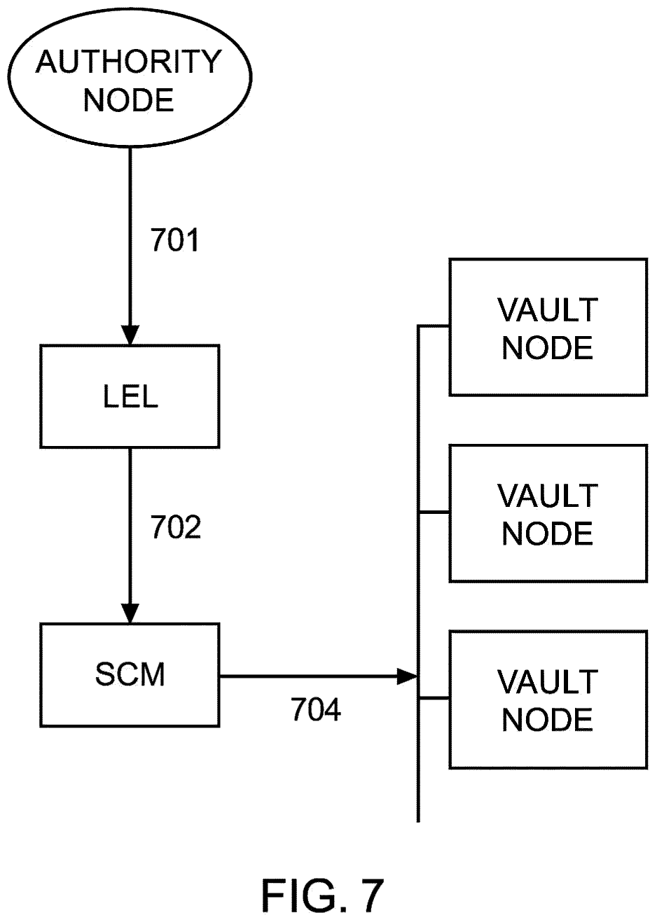

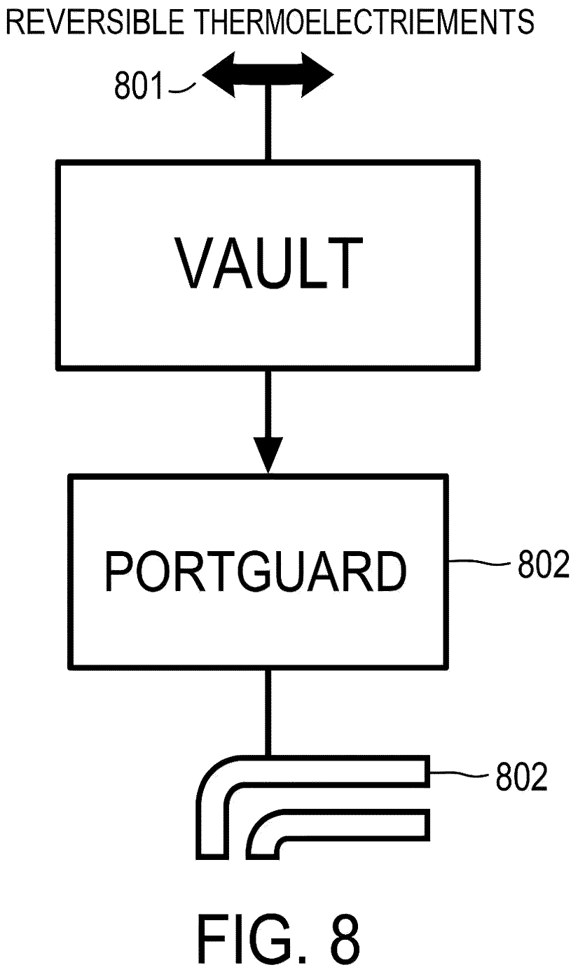

### FIELD OF THE INVENTION

The present invention relates to hybrid resource-harvesting and infrastructure validation systems. More specifically, the invention concerns secure apparatuses, methods, and control logic for harvesting, converting, storing, validating, and conditionally releasing resources under cryptographic enforcement.

### BACKGROUND OF THE INVENTION

Emerging micro-infrastructure networks increasingly rely on secure, verifiable resource harvesting and storage systems that prevent unauthorized access, tampering, or falsification. Traditional decentralized infrastructure lacks tamper-proof validation mechanisms, cryptographically enforced release conditions, dual-meter discrepancy detection, and sealed operational states resistant to intrusion. Existing systems also fail to provide hardware-enforced escrow validation or post-quantum security guarantees. There is a need for a system integrating multi-domain harvesting, secure conversion and storage, cryptographic enforcement, post-quantum validation, and immutable compliance documentation within a single apparatus.

### SUMMARY OF THE INVENTION

The Forta Vault is a sovereign-grade apparatus and control architecture for harvesting resources from multiple environmental domains, converting the harvested resources into usable outputs, securely storing them, and conditionally releasing them based on cryptographically validated requirements. The apparatus includes a multi-modal environmental harvesting assembly, a conversion module, a storage module, a dual-meter validation system, a hardware security module (HSM) enforcing sealed operational states, a tamper-detection system, and an escrow-validation engine capable of verifying contractual, regulatory, sustainability, or operational conditions before resource release. The system further generates post-quantum cryptographically signed telemetry, evidence packets, and immutable sustainability or compliance records suitable for distributed ledger anchoring. The invention also comprises methods for secure harvesting, conversion, storage, validation, and controlled release, as well as a non-transitory computer-readable medium storing instructions for executing these processes autonomously or within distributed Vault networks.

### DETAILED DESCRIPTION OF THE INVENTION

The Forta Vault comprises an integrated hardware and software architecture for secure harvesting, conversion, validation, and release of resources. The following description provides embodiments of the apparatus, method, and control logic. Variations may be implemented without departing from the scope of the invention.
1. Multi-Modal Environmental Harvesting Assembly

The harvesting assembly may include thermal differential harvesters, electromagnetic or RF harvesters, kinetic or vibration micro-generators, humidity-capture systems, or waste-conversion modules producing fuel or heat. These modules operate independently or cooperatively to deliver collected inputs to the conversion module.

### 2. Conversion Module

The conversion module transforms harvested resources into usable formats, such as thermal-to-electrical conversion, humidity-to-water extraction, or waste-to-fuel synthesis. The converted output is forwarded to the storage module.

### 3. Storage Module

The storage module stores converted resources electrically, chemically, thermally, or mechanically. Stored resources remain locked until release conditions are validated.

### 4. Dual-Meter Validation

A primary and secondary meter independently measure harvested or stored quantities. Discrepancies beyond a defined threshold trigger sealed mode.

### 5. Hardware Security Module (HSM)

The HSM manages cryptographic keys, enforces sealed operational states, validates escrow conditions, generates post-quantum signatures, and zeroizes keys upon tampering.

### 6. Tamper Detection

Tamper detection may include enclosure sensors, integrity sensors, magnetic seal-break detection, or environmental anomaly detection. Detected tampering initiates sealed mode.

### 7. Escrow-Validation Engine

This engine evaluates contractual, regulatory, sustainability, or operational conditions encoded in the HSM. Resource release occurs only after cryptographic validation.

### 8. Software Embodiment

A non-transitory computer-readable medium stores instructions for harvesting management, conversion cycles, dual-meter reconciliation, sealed state control, post-quantum telemetry generation, consensus validation, microgrid operation, and scarcity licensing enforcement.

1. A resource-harvesting and enforcement apparatus comprising:
an environmental harvesting assembly configured to physically collect energy or other resources from a plurality of environmental domains;
a conversion module configured to physically transform the collected resources into a usable output form;
a storage module configured to physically retain the usable output;
a dual-meter validation module comprising a primary meter and a secondary meter configured to detect physical discrepancies in harvested or stored resource quantities;
a hardware security module (HSM) configured to maintain sealed operational states, generate cryptographic keys, enforce physical resource-release conditions, and perform cryptographic signing;
a tamper-detection module configured to detect unauthorized physical access or modification; and
an escrow-validation engine configured to restrict physical release of the stored resource until verification of one or more cryptographically validated conditions.

2. The apparatus of claim 1, wherein the environmental harvesting assembly comprises thermal, electromagnetic, kinetic, humidity-capture, or waste-conversion harvesting elements.

3. The apparatus of claim 1, wherein the conversion module comprises thermal-to-electrical conversion, humidity-to-water extraction, or waste-to-fuel synthesis.

4. The apparatus of claim 1, wherein the storage module comprises electrical storage, chemical storage, thermal mass, or mechanical storage.

5. The apparatus of claim 1, wherein the dual-meter validation module initiates a sealed operational state upon detecting a discrepancy above a predefined physical tolerance threshold.

6. The apparatus of claim 1, wherein the HSM is configured to zeroize cryptographic keys upon detection of a physical tamper event.

7. The apparatus of claim 1, wherein the tamper-detection module comprises intrusion sensors, enclosure integrity sensors, or magnetic seal-break sensors.

8. The apparatus of claim 1, wherein the escrow-validation engine writes transaction verification data to a distributed ledger for physical resource accountability.

9. The apparatus of claim 1, wherein the stored resource is physically released only after validation of sustainability, compliance, or authorization conditions encoded in the HSM.

10. A method for secure harvesting, conversion, validation, and release of resources, the method comprising:
physically harvesting resources from a plurality of environmental domains;
physically converting the harvested resources into a usable output;
physically storing the usable output;
validating harvested or stored quantities via a dual-meter physical comparison;
maintaining sealed operational states using a hardware security module (HSM);
generating cryptographic signatures or evidence packets;
verifying escrow conditions; and
physically releasing at least a portion of the stored output only after the escrow conditions are cryptographically validated.

11. The method of claim 10, further comprising generating a tamper-resistant sustainability or compliance record associated with the physical release of the resource.

12. The method of claim 10, wherein sealed operational states are triggered by detection of a physical tamper condition or a meter discrepancy beyond a predefined tolerance.

13. The method of claim 10, wherein the escrow conditions comprise contractual, regulatory, or sustainability authorization requirements.

14. The method of claim 10, further comprising transmitting cryptographically signed telemetry reflecting physical resource state to one or more external systems.

15. A non-transitory computer-readable medium storing instructions which, when executed by one or more processors, cause a system to:
manage physical harvesting and conversion operations;
perform dual-meter physical validation;
control sealed operational states;
execute cryptographic signing;
generate evidence packets;
validate escrow conditions; and
authorize or restrict physical resource release based on escrow validation.

16. The medium of claim 15, wherein the instructions cause the system to perform continuity validation among a plurality of distributed storage apparatuses.

17. The medium of claim 15, wherein the instructions cause the system to manage islanded or isolated infrastructure operation.

18. The medium of claim 15, wherein the instructions cause the system to update or revoke cryptographic material based on detected physical tampering.

19. The medium of claim 15, wherein the instructions cause the system to generate immutable sustainability or ESG verification records associated with physical resource handling.

20. The medium of claim 15, wherein the instructions cause the system to enforce scarcity or allocation constraints encoded within the hardware security module.

21. The apparatus of claim 1, wherein the storage module is configured to exchange physical reserve state information with a plurality of geographically distributed storage apparatuses to preserve continuity across a distributed resource infrastructure.

22. The apparatus of claim 21, wherein the reserve state information comprises available physical capacity, stored quantity, or physical release eligibility.

23. The apparatus of claim 21, wherein coordination among the plurality of storage apparatuses is performed without centralized dispatch control.

24. The apparatus of claim 1, wherein the apparatus automatically transitions into a predefined physical operational state when a stored resource quantity exceeds a threshold associated with continuity preservation.

25. The apparatus of claim 24, wherein the predefined physical operational state comprises authorizing conditional physical transfer, deferring physical intake, or suspending nonessential physical release.

26. The apparatus of claim 24, wherein the threshold is adjustable based on reserve obligations, infrastructure classification, or jurisdictional requirements.

27. The apparatus of claim 1, wherein the apparatus is configured to enter a monitoring state in which active physical resource transfer is suspended while storage integrity and demand conditions continue to be physically evaluated.

28. The apparatus of claim 27, wherein the apparatus exits the monitoring state automatically upon satisfaction of a predefined physical continuity condition.

29. The apparatus of claim 1, wherein stored resources are selectively physically released to a public authority or private entity under a predefined continuity authorization.

30. The apparatus of claim 29, wherein the release occurs during an emergency or scarcity condition without requiring manual operator intervention.

31. The apparatus of claim 1, further comprising an interface configured to receive external operational guidance relating to physical demand conditions or policy constraints.

32. The apparatus of claim 31, wherein the apparatus remains fully operable in the absence of the external operational guidance.
